(19) United States
(12) Patent Application Publication
(10) Pub. No.: US 2010/0115031 A1
(43) Pub. Date: May 6, 2010

(54) System and Method For Enabling P2P Applications in a Wireless Mobile Network

(75) Inventors: Yonghua Lin, Beijing (CN); Ling Shao, Beijing (CN); Yi Xin Zhao, Beijing (CN); Kai Zheng, Beijing (CN)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/608,198

(22) Filed: Oct. 29, 2009

(30) Foreign Application Priority Data
Oct. 31, 2008 (CN) 200810173269.4

(51) Int. Cl. G06F 15/16

(52) U.S. Cl. 709/204

(57) ABSTRACT

A system, method, and computer readable article of manufacture for enabling peer-to-peer (P2P) applications in a wireless mobile network. The system includes: a uniform resource identifier (URI) request analyzer module to intercept and analyze a request from a mobile terminal to capture content; and at least one P2P content service agent module to obtain the content locally or over a computer network acting as a P2P peer according to the content request captured by the URI request analyzer module, and to transfer the content to the mobile terminal.

### CROSS-REFERENCE TO RELATED APPLICATION

This application claims priority under 35 U.S.C. §119 from Chinese Patent Application No. 200810173269.4 filed on Oct. 31, 2008, the entire contents of which are incorporated herein by reference.

### BACKGROUND OF THE INVENTION

1. Field of the Invention

The present invention relates to the field of peer-to-peer (P2P) applications. More particularly, the present invention relates to a system and method for enabling P2P applications in a wireless mobile network.

2. Description of Related Art

P2P is an efficient data transmission approach which enables a user to obtain contents efficiently and reliably in a distributed and collaborative environment. P2P works in such a way that one P2P peer serves other P2P peers and gets served by other P2P peers. As a result of this feature, various types of P2P application software such as BitTorrent (BT) and Emule, for example, have been developed and have been popularized rapidly. Currently, there is a great quantity of contents that is being delivered through P2P over the Internet.

Different types of applications can be built for different real time requirements based upon P2P. For example, a user can play a movie after he or she gets the whole movie file through P2P. Also, the user can play an audio file in real-time while he or she gets the audio stream continuously by means of P2P.

With the development and popularization of wireless mobile technologies, mobile terminals such as mobile phones have become the most common intelligent terminals for users. The number of mobile phones has become much larger than the number of computers. Such a phenomenon can be expected to persist for existing wireless mobile networks such as the GSM network, the CDMA network, 4G networks, and the WiMax network that will be put onto the market soon.

Therefore, it will be of significant commercial value for wireless mobile network carriers to enable P2P applications for such a large group of mobile terminal users in a wireless mobile network. Unfortunately, no effective solution for enabling P2P applications in a wireless mobile network is present so far for the following reasons.

It is difficult for a mobile terminal to serve other clients as a P2P peer. Since the mobile terminal is typically battery-powered and it needs to transmit over long time periods to share contents, this can lead to unacceptable power consumption, greatly reducing the working time of the mobile phone.

Wireless bandwidth is more expensive than wired bandwidth. More specifically, for each wireless base station, the maximum number of channels allocated for service connections is limited. P2P activities, such as downloading and sharing, require a large number of connections, which will occupy much of the limited resources of base stations.

Furthermore, mobile terminals have different and limited capacities from that of wired terminals. For example, they have smaller screens with relatively lower resolution compared with normal computers. Also, mobile terminals have limited processing capacity and storage capacity. For example, popular high-definition (HD) media transmitted over the Internet, a network of interconnected computers, can not be played by mobile terminals.

In addition, since a variety of types of P2P client software are currently available over the Internet, it can be cumbersome for a user to install client software on a mobile terminal in order to enable the various P2P applications.

### SUMMARY OF THE INVENTION

In view of the above problems in the existing art, an object of the invention is to provide a system and a method for enabling P2P applications in a wireless mobile network, which can solve one or more of the existing problems.

Therefore, in a first aspect of the present invention, there is provided a system for enabling peer-to-peer (P2P) applications in a wireless mobile network. The system includes: a uniform resource identifier (URI) request analyzer module to intercept and analyze a request from a mobile terminal to capture content; and at least one P2P content service agent module to obtain the content locally or over a computer network acting as a P2P peer according to the content request captured by the URI request analyzer module, and to transfer the content to the mobile terminal.

In another aspect of the present invention, there is provided a method implemented by a computing apparatus for enabling peer-to-peer (P2P) applications in a wireless mobile network. The method includes: intercepting, by a uniform resource identifier (URI) request module, a request from a mobile terminal to capture content; analyzing, by the URI request module, the request from the mobile terminal; obtaining, by a P2P content service agent module, the content according to the request from the mobile terminal acting as a P2P peer, wherein the content is obtained locally or over a computer network; and transferring the content, by the P2P content service module, to the mobile terminal, thereby enabling P2P applications in the wireless mobile network by the computing apparatus.

In still another aspect of the present invention, there is provided a computer readable article of manufacture tangibly embodying computer readable instructions for executing the computer implemented method.

### BRIEF DESCRIPTION OF THE DRAWINGS

The objects, features and advantages of the invention will become apparent from the following descriptions of the embodiments of the present invention with reference to the drawings. In the drawings, identical or corresponding reference numbers are used to denote identical or corresponding technical features or components.

FIG. 1 illustrates a schematic diagram showing the environment of a system for enabling P2P applications in a wireless mobile network according to an embodiment of the present invention.

FIG. 2 is a block diagram of an exemplary structure of the system for enabling P2P applications in the wireless mobile network illustrated in FIG. 1.

FIG. 3 is a block diagram of an exemplary structure of a P2P content service agent illustrated in FIG. 2.

FIG. 4 is a general flow chart of a method for enabling P2P applications in a wireless mobile network according to an embodiment of the present invention.

FIG. 5 is a block diagram of an exemplary structure of a computer in which an embodiment of the present invention can be implemented.

### DETAILED DESCRIPTION OF THE PREFERRED EMBODIMENTS

The technical solutions according to the embodiments of the present invention have at least one or more of the advantages described below.

P2P application can be enabled effectively in a wireless mobile network. Specifically, the P2P work principle can be maintained while the power consumption of mobile terminals can be reduced. Mobile users can enjoy P2P contents originating from the Internet, i.e., a computer network, without installing any P2P client software on the mobile terminal.

Value-added services can be created for wireless mobile network carriers.

The embodiments of the present invention are friendly to the Internet. Specifically, no substantial traffic impact will be brought to the Internet, while Internet users can be provided with additional resources.

Exemplary embodiments of the present invention will be described in conjunction with the accompanying drawings. For the sake of clarity and conciseness, not all the features of actual implementations are described in the specification. However, it is to be appreciated that, during the development of actual implementations numerous implementation-specific decisions must be made to achieve the developer's specific goals.

It is noted that only device structures and/or processing steps closely relevant to solutions of the invention will be illustrated in the drawings. Other details less relevant to the invention are omitted so as not to obscure the invention.

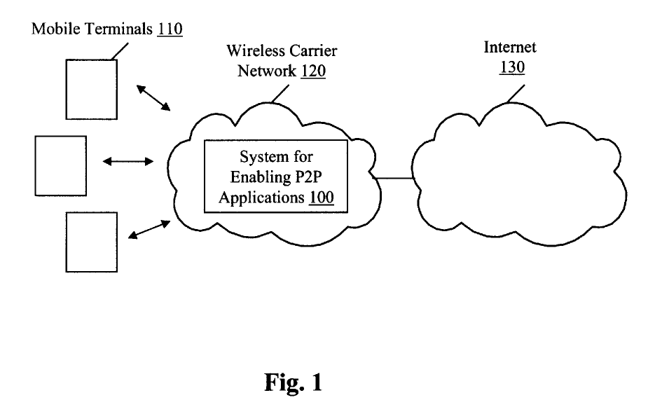

FIG. 1 illustrates a schematic diagram of an environment in which a system 100 for enabling P2P applications in a wireless mobile network according to an embodiment of the invention operates. As illustrated in FIG. 1, the system 100 can be deployed in a wireless carrier network 20 as a part of its content service platform and also between one or more mobile terminals 110 and the Internet 130.

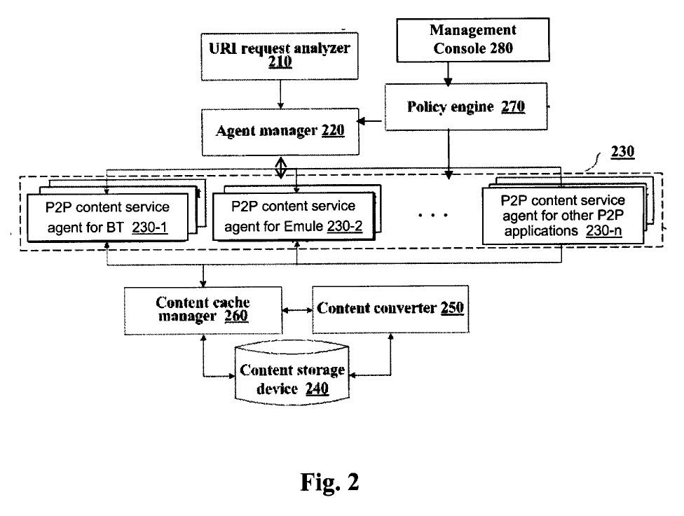

FIG. 2 shows a block diagram of an exemplary structure of the system 100 for enabling P2P applications in a wireless mobile network as illustrated in FIG. 1. As shown in FIG. 2, the system 100 can include a uniform resource identifier (URI) request analyzer module 210, an agent manager module 220, a P2P content service agent module 230, a content storage device 240, a content converter module 250, a content cache manager module 260 and a policy engine module 270.

The URI request analyzer module 210 can intercept and analyze a URI request from a mobile terminal to capture a P2P content request. Specifically, if the intercepted URI request is for obtaining a seed file of a P2P application of a specific type, then the URI request analyzer module 210 can determine the request as a P2P content request and capture it for further processing. Otherwise, the URI request analyzer can ignore the request, in which case the request will be transmitted to its intended destination.

Currently, there are more than ten types of P2P application software available on the Internet, e.g., BT and Emule. When the embodiment of the present invention is implemented, a part or all of these or future P2P applications can be enabled based on their different requirements. Thus, at least one P2P content service agent module 230 can include one or more P2P applications, for example, a P2P content service agent module 230-1 for BT, a P2P content service agent module 230-2 for Emule, . . . , a P2P content service agent module 230-n for another type of P2P application, as illustrated in FIG. 2. The agent manager module 220 can invoke a corresponding type of P2P content service agent module in accordance with the type of the P2P content request captured by the URI request analyzer module 210.

Further, each of the types of P2P content service agent modules 230-1, 230-2, . . . , 230-n can include one or more application examples in view of factors such as performance or bandwidth, for example. The agent manager module 220 can be omitted in the system 100 in a simplified case. An example is in the case for which the system enables only one type of P2P application and the corresponding type of P2P content service agent module includes only one example.

The P2P content service agent module 230 can obtain P2P content locally or over the Internet, acting as a P2P peer according to the P2P content request captured by the URI request analyzer module 210 and then transfer the P2P content to the mobile terminal. Specifically, the P2P content service agent module 230 can first determine whether the P2P content is locally available, and then directly obtain the P2P content locally in the case that the P2P content is locally available, or it can download the P2P content over the Internet acting as a P2P peer in the case that the P2P content is not locally available. Of course, the P2P content service agent module 230 can alternatively not make the above determination, but can simply download the P2P content over the Internet acting as a P2P peer.

The content storage device 240 can store as local contents the P2P contents downloaded over the Internet by the P2P content service agent module 230. The content storage device 240 can be omitted in the system 100 in the case where the system does not cache the downloaded P2P contents.

The content converter module 250 can convert the P2P content obtained over the Internet into content suitable for the mobile terminal, where the P2P content service agent module 230 can transfer the content suitable for the mobile terminal to the mobile terminal. Here, the content suitable for the mobile terminal refers to such content whose encoding format, resolution, and size, for example, comply with characteristics of the mobile terminal, e.g., processing capacity, screen resolution, and storage capacity. Such content is capable of being used by the mobile terminal. For example, in the case where the encoding format of the P2P content obtained over the Internet cannot be supported by the mobile terminal, the content converter module 250 can change the encoding format of the P2P content to an encoding format supported by the mobile terminal so as to make it suitable for the mobile terminal.

Furthermore, in the case where the resolution of the P2P content obtained over the Internet exceeds the screen resolution of the mobile terminal, the content converter module 250 can adjust the resolution of the P2P content so as to make it suitable for the mobile terminal. Furthermore, in the case where the data size of the P2P content obtained over the Internet exceeds the available storage capacity of the mobile terminal, the content converter 250 can split the P2P content into several parts so as to each part suitable for the mobile terminal.

The content converter module 250 can perform content conversion according to a predetermined policy, for example, according to whether a mobile subscriber has subscribed for the conversion service. Furthermore, the content converter module 250 can transfer the content suitable for the mobile terminal to the content storage device 240 for storage as local content, so that the P2P content service agent module can publish the content suitable for the mobile terminal as new content. The content converter module 250 can be omitted in the system 100 depending on specific design, for example, in the case that the system does not support content conversion.

The content cache manager module 260 can manage access to the local contents in the content storage device 240. For example, the content cache manager module 260 can determine whether to cache the downloaded P2P content based upon the popularity of the P2P content, e.g., the number of times it is downloaded, determine where to buffer the downloaded P2P content in the case that, for example, the content storage device 240 is a distributed database, and determine which content should be swapped out for the storage of newly downloaded P2P content in the case that, for example, the content storage device 240 is full. The content cache manager module 260 can be omitted in the system 100 depending on the specific system design.

The policy engine module 270 can control the behavior of the system through various policy settings input by an administrator via a management console 280. For example, it can control which types of P2P content requested is to be captured, whether to invoke the P2P content agent manager module, how many P2P content service agent modules are to be initiated, and whether and when to convert contents. The policy engine module 270 can be omitted in the system 100 depending on the details of the specific design.

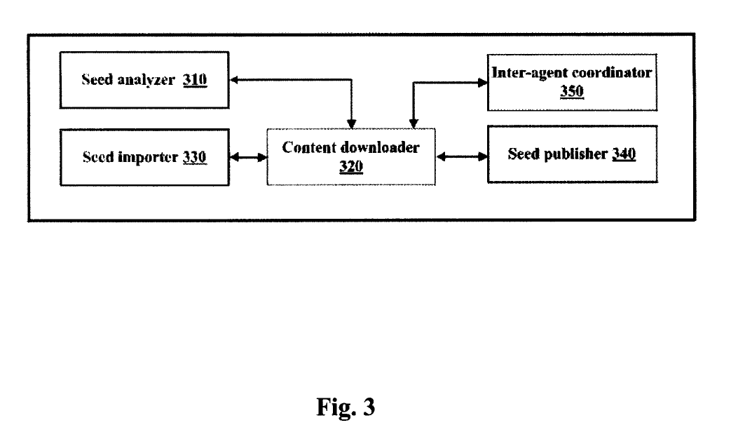

A specific structure of the P2P content service agent module 230 is described below by using the P2P content service agent for BT as an example. FIG. 3 illustrates a block diagram of an exemplary structure of the P2P content service agent 230 shown in FIG. 2. As illustrated in FIG. 3, the P2P content service agent module 230 can further include a seed analyzer module 310, a content downloader module 320, a seed importer module 330, a seed publisher module 340 and an inter-agent coordinator module 350.

The seed analyzer module 310 can obtain a corresponding seed file according to the P2P content request captured by the URI request analyzer module 210, for example, a request for obtaining a BT seed file with an extension of “torrent”, and analyze the obtained seed file to obtain information on the P2P content, e.g., content identification, content type, and where to obtain the content.

The content downloader module 320 can download the P2P content from one or more other P2P peers by establishing P2P sessions with the other P2P peers over the Internet in accordance with the information on the P2P content, which is obtained by the seed analyzer module 310.

The seed importer module 330 can obtain a seed file from a third party in order to download corresponding P2P content in advance of use as local content. For example, the seed importer module 330 can obtain a seed file of desired content from, for example, a BT content publishing website in order to download the corresponding content in advance of use through the content downloader module 320. The seed importer module 330 can be omitted in the P2P content service agent 230 depending on specific design details.

In order to maintain the completeness of the P2P protocol, the seed publisher module 340 can publish information on local content with a new seed, so that other P2P peers can download the local content. Thus, the P2P content agent can complete the duty of a P2P peer on behalf of all the mobile phones it serves. The seed publisher module 340 can be omitted in the P2P content service agent module 230 depending on specific design details.

The inter-agent coordinator module 350 can support collaboration with a P2P content service agent in another system based on factors such as performance, efficiency, for example, in order to facilitate the downloading of P2P content. For example, the same wireless carrier deploys the systems at both Boston and Chicago, and thus the collaboration between the P2P content service agent modules in the systems at the two cities can be enabled through the inter-agent coordinator module 350. The inter-agent coordinator module 350 can be omitted in the P2P content service agent 230 depending on specific design details.

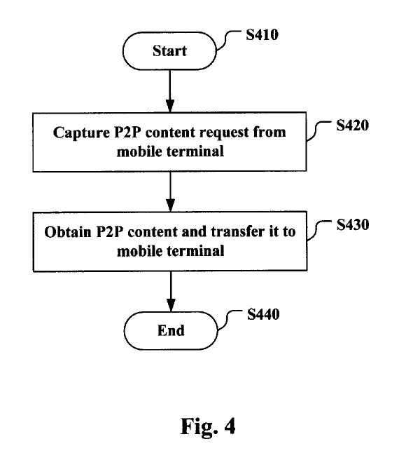

FIG. 4 illustrates a general flow chart of the method for enabling P2P applications in a wireless mobile network according to an embodiment of the invention. As illustrated in FIG. 4, the processing flow of the method starts with the step S410. In the step S420, a URI request from a mobile terminal is intercepted and analyzed to capture a P2P content request related to specific P2P content. In the step S430, the P2P content is obtained locally or over the Internet and then is transferred to the mobile terminal.

An exemplary typical scenario in which the present invention is applied is detailed below in order to better describe the system and method according to the embodiments of the present invention described above.

First, a mobile user sees a link to an interesting movie in the web browser of a mobile terminal, where the link points to the content to be downloaded through BT, i.e., a seed file of a type of P2P content, for example, a BT seed file of a.torrent. Then, the user clicks on the link, so that the mobile terminal sends out a corresponding hypertext transfer protocol (HTTP) request.

The request is intercepted by the URI request analyzer module. Next, the URI request analyzer module determines that the request is a request for obtaining the BT seed file of a.torrent, i.e., a P2P content request. As a result, the URI analyzer directs the request to the agent manager module. Next, the agent manager module invokes the P2P content service agent module for BT for further processing.

In the case that the movie is not available locally, the invoked P2P content service agent module for BT downloads the movie by establishing P2P sessions with other P2P peers over the Internet, and then converts the movie into one suitable for the mobile terminal, if necessary. It then stores the downloaded movie or the converted movie suitable for the mobile terminal in the content storage device.

Next, the P2P content agent module generates an HTTP response in which the movie stored in the content storage device is designated for playing or storage by the mobile terminal. It sends the response back to the mobile terminal.

Finally, the mobile terminal plays the movie in a streaming mode through a player in the browser, or stores the whole movie in its own storage device and then plays the movie.

As is apparent from the above, according to the embodiment of the present invention, since it is not necessary for the mobile terminal to download and share P2P contents as a P2P peer itself, P2P applications can be enabled effectively in a wireless mobile network while power the consumption of the mobile terminal is reduced. It is not necessary to install any P2P client software on the mobile terminal.

The above system and method can be implemented by using hardware. Such hardware can be a single processing device or a plurality of processing devices. Such a processing device can be a microprocessor, a microcontroller, a digital processor computing apparatus, a microcomputer, a part of a central processing unit, a state machine, a logic circuit and/or any device capable of manipulating a signal.

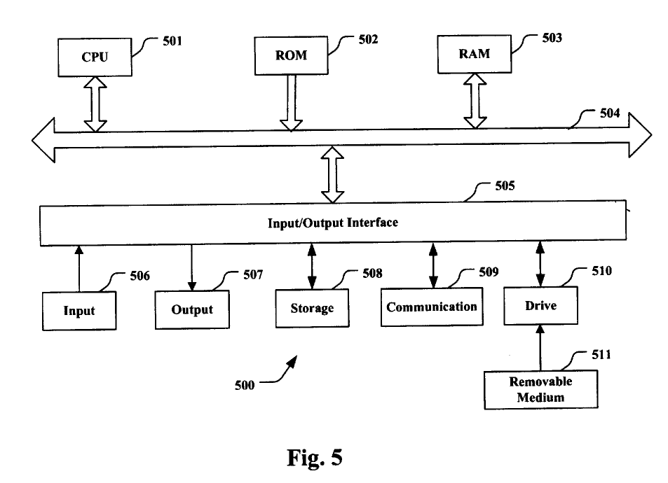

The above system and method can be implemented by either software or firmware. In the case where the above system and method are implemented by software, a program that constitutes the software is installed, from a storage medium or a network, into a computing apparatus having a dedicated hardware configuration, e.g., a general-purpose personal computer 500 as illustrated in FIG. 5, that when programs are installed in it, becomes capable of performing the various functions of the program.

In FIG. 5, a central processing unit (CPU) 501 performs processes in accordance with a program stored in a read only memory (ROM) 502 or a program loaded from a storage device 508 to a random access memory (RAM) 503. In the RAM 503, data required when the CPU 501 performs the processes is also stored as required. The CPU 501, the ROM 502 and the RAM 503 are connected to one another via a bus 504. An input/output interface 505 is also connected to the bus 504.

The following components are connected to input/output interface 505: an input module 506 including a keyboard and a mouse; an output module 507 including a display such as a cathode ray tube (CRT), a liquid crystal display (LCD), and a loudspeaker; a storage module 508 including a hard disk; and a communication module 509 including a network interface card such as a LAN card, and a modem. The communication section 509 performs communication processes via a network such as the Internet.

A drive 510 is also connected to the input/output interface 505 as required. A removable medium 511, such as a magnetic disk, an optical disk, a magneto-optical disk, or a semiconductor memory, is mounted on the drive 510 as required, so that a computer program read from it is installed in the storage module 508 as required.

In the case where the above-described series of processes are implemented by software, the program that constitutes the software is installed from a network such as the Internet or a storage medium such as the removable medium 511. Examples of the removable medium 511 include a magnetic disk, a floppy disk, an optical disk, a compact disk, a read only memory, CD-ROM, a digital versatile disk (DVD), a magneto-optical disk, a mini-disk (MD), and a semiconductor memory. Alternatively, the storage medium can be the ROM 502 or a hard disk contained in the storage module 508, which contains the stored program.

It should also be noted that the steps in which the above-described series of processes are performed can be performed in order of description but need not be performed in that order. Some steps can be performed in parallel or independently of one another.

While the present invention has been described with reference to what are presently considered to be the preferred embodiments, it is to be understood that the present invention is not limited to the disclosed embodiments. On the contrary, the present invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A system for enabling peer-to-peer (P2P) applications in a wireless mobile network, comprising:
a uniform resource identifier (URI) request analyzer module to intercept and analyze a request from a mobile terminal to capture content; and
at least one P2P content service agent module to obtain the content locally or over a computer network acting as a P2P peer according to the content request captured by the URI request analyzer module, and to transfer the content to the mobile terminal.

2. The system according to claim 1, wherein the at least one P2P content service agent module comprises one or more types of service agent module, wherein each corresponds to one type of content.

3. The system according to claim 2, further comprising:
an agent manager module to invoke the type of P2P content service agent module corresponding to the type of content requested by the mobile terminal when the request to capture content is directed to it by the URI request analyzer module.

4. The system according to claim 1, further comprising:
a content storage device to store as local content the content obtained over the computer network by the P2P content service agent module.

5. The system according to claim 1, further comprising:
a content converter module to convert the content obtained over the computer network into content suitable for the mobile terminal.

6. The system according to claim 5, wherein the content converter module transfers the content suitable for the mobile terminal to a content storage device for storage therein as local content.

7. The system according to claim 1, wherein the P2P content service agent module further comprises:
a seed analyzer module to obtain a seed file according to the content request captured by the URI request analyzer module, and to analyze the obtained seed file to obtain information on the content; and
a content downloader module to download the content from one or more P2P peers by establishing P2P sessions with the P2P peers over the computer network according to the information on the content obtained by the seed analyzer module.

8. The system according to claim 1, wherein the P2P content service agent module further comprises:
a seed importer module to obtain a seed file from a third party in order to download content corresponding to the seed file in advance of use as local content.

9. The system according to claim 1, wherein the P2P content service agent module further comprises:
a seed publisher module to publish a new seed containing information on local content.

10. The system according to claim 1, wherein the P2P content service agent further comprises:
an inter-agent coordinator module to support collaboration with a P2P content service agent module in another system.

11. A method implemented by a computing apparatus to enable peer-to-peer (P2P) applications in a wireless mobile network, comprising:
intercepting, by a uniform resource identifier (URI) request module, a request from a mobile terminal to capture content;
analyzing, by the URI request module, the request from the mobile terminal;
obtaining, by a P2P content service agent module, the content according to the request from the mobile terminal acting as a P2P peer, wherein the content is obtained locally or over a computer network; and
transferring the content, by the P2P content service module, to the mobile terminal, thereby enabling P2P applications in the wireless mobile network by the computing apparatus.

12. The method according to claim 11, further comprising:
directing by the URI request analyzer module the request to capture content to an agent manager module; and
invoking by the agent manager module a type of P2P content service agent module according to type of the content requested by the mobile terminal.

13. The method according to claim 11, further comprising:
storing by a content storage device as local content the content obtained over the computer network by the P2P content service module.

14. The method according to claim 11, further comprising:
converting by a content converter module the content obtained over the computer network into content suitable for the mobile terminal;
transferring by the P2P content service agent module the content suitable for the mobile terminal to the mobile terminal.

15. The method according to claim 11, further comprising:
converting by a content converter module the content obtained over the computer network into content suitable for the mobile terminal;
transferring by the P2P content service agent module the content suitable for the mobile terminal to a content storage device for storage therein as local content.

16. The method according to claim 11, wherein obtaining the P2P content over the computer network further comprises:
obtaining by a seed analyzer module a seed file according to the content request;
analyzing by the seed analyzer module the obtained seed file to obtain information on the content; and
downloading by a content downloader module the content from one or more P2P peers by establishing P2P sessions with the P2P peers over the computer network according to the obtained information on the content.

17. The method according to claim 11, further comprising:
obtaining a seed file by a seed importer module from a third party; and
downloading by a content downloader module corresponding P2P content in advance of use as local content.

18. The method according to claim 11, further comprising:
publishing by a seed publisher module a new seed containing information on local content.

19. A computer readable article of manufacture tangibly embodying computer readable instructions which, when executed, cause a computing apparatus to implement a method for enabling peer-to-peer (P2P) applications in a wireless mobile network, comprising the steps of:
intercepting, by a uniform resource identifier (URI) request module, a request from a mobile terminal to capture content;
analyzing, by the URI request module, the request from the mobile terminal;
obtaining, by a P2P content service agent module, the content according to the request from the mobile terminal acting as a P2P peer, wherein the content is obtained locally or over a computer network; and
transferring the content, by the P2P content service module, to the mobile terminal.
